(19) United States
(12) Patent Application Publication
(10) Pub. No.: US 2015/0219275 A1
(43) Pub. Date: Aug. 6, 2015

(54) SPORT HOLDER FOR VEHICLE OR HOME DOOR OR WALL

(71) Applicant: James Grant, Colorado Springs, CO (US)

(72) Inventor: James Grant, Colorado Springs, CO (US)

(21) Appl. No.: 14/330,575

(22) Filed: Jul. 14, 2014

Related U.S. Application Data
(60) Provisional application No. 61/934,948, filed on Feb. 3, 2014.

(51) Int. Cl. F16M 13/02; B60R 9/12; A63C 11/00

(52) U.S. Cl. CPC F16M 13/022; A63C 11/00; B60R 9/12

(57) ABSTRACT

A portable sport holder includes a body having an upper end, a lower end, and a pair of projections disposed between the upper and lower ends for receiving and stabilizing a piece of equipment. The pair of projections forms a V-shaped basket for receiving the piece of equipment. A neck extends from the upper end of the body. A head extends from the neck, whereby the head is adapted to removably couple the sport holder to a mounting surface.

### CROSS-REFERENCE TO RELATED APPLICATIONS

This application claims priority to U.S. Provisional Application No. 61/934,948 filed Feb. 3, 2014 and entitled “SPORT HOLDER FOR AUTO OR HOME DOOR,” the entire disclosure of which is hereby incorporated by reference for all purposes, as if fully set forth herein.

### BACKGROUND OF THE INVENTION

Storage of sporting equipment is often difficult, particularly while travelling away from home to outdoor destinations where appropriate storage mechanisms are not available. In such cases, it is often inconvenient or undesirable to place the equipment on the ground, where the equipment may be become quickly soiled. For instance, skiers often lean their skis and/or poles upright against their vehicles while they put on ski boots and other athletic gear after arriving at a skiing venue. Placement of the ski equipment in this way is often precarious and leads to the equipment tipping over and sliding along the vehicle to the ground. This may result in damage to the vehicle, such as scraped paint, dents, and broken parts, as well as damage to the ski equipment, such as broken ski poles and/or skis. Falling equipment may also pose a safety hazard to the skier and any bystanders. Therefore, there is a need to provide portable storage for securely receiving sport equipment that is convenient for a user. This disclosure is intended to address the above-noted concerns and to provide related advantages.

### SUMMARY

In one embodiment, the disclosure provides a portable sport holder that comprises a planar body having an upper end, a lower end, and a pair of projections disposed between the upper and lower ends for receiving and stabilizing a piece of equipment. The pair of projections forms a V-shaped basket for receiving the piece of equipment therein. A neck extends from the upper end of the body. Further, a head extends from the neck, wherein the head is adapted to removably couple the sport holder to a mounting surface.

In other embodiments, the disclosure provides a portable sport holder comprising a body having an upper end, a lower end, and at least one angled projection disposed between the upper and lower ends. A neck extends from the upper end of the body. A head extends from the neck, wherein the head is adapted to removably couple the sport holder to a mounting surface. The at least one angled projection is adapted to removably secure a piece of equipment, and to removably receive a sport-specific overlay.

Still, in other embodiments, the disclosure provides a method for attaching a piece of equipment to a portable sport holder. The method comprises the step of providing a body having an upper end, a lower end, and a pair of projections disposed therebetween for receiving and stabilizing a first piece of equipment therein. The method further comprises the step of providing a neck extending from the upper end of the body, wherein the neck is further adapted to attach to a head that provides a slot therethrough. A further step includes inserting a mounting hook through the slot to engage a periphery of the slot against a stop on the mounting hook. Even further the method includes the steps of engaging the mounting hook to a mounting surface and placing the first piece of equipment between the pair of projections to hang or hold the first piece of equipment therein.

### BRIEF DESCRIPTION OF THE DRAWINGS

FIG. 1 is a perspective view of a vehicle equipped with a sport holder according to the invention;

FIG. 2 illustrates the sport holder of FIG. 1 while holding a pair of skis according to the invention;

FIG. 3 is a side view of the sport holder of FIG. 1;

FIG. 4 is a front view of the sport holder of FIG. 1;

FIG. 5 is a rear view of the sport holder of FIG. 1;

FIG. 6 is a cross sectional side view of a head of the sport holder of FIG. 7 taken along lines 6-6;

FIG. 7 is a front view of the sport holder of FIG. 1 deployed on a vehicle and holding a pair of skis.

FIG. 8 is a front view of a different sport holder according to various embodiments of the present invention;

FIG. 9 is side angled view of the sport holder of FIG. 8;

FIG. 10 is a perspective view of yet another sport holder according to various embodiments of the present invention; and

FIG. 11 is a top perspective view of still another sport holder according to various embodiments of the present invention.

### DETAILED DESCRIPTION OF THE INVENTION

The present disclosure describes a sport holder that offers a convenient place for a user to temporarily stow their equipment while they attend to other tasks. Merely by way of example, the sport holder may secure a pair of skis to a vehicle for transportation and/or temporary storage while the user or skier makes other ski preparations, such as donning ski boots, a coat, and/or preparing other ski apparel, equipment and accessories. In this case, the skier attaches the sport holder to the vehicle and secures their skis to the sport holder, rather than balancing the skis by leaning them, along with the poles, directly against the vehicle. It is contemplated that the sport holder prevents the skis from sliding and falling onto the ground, which often occurs where skis rest directly against the vehicle without any restraint. In that case, the skis may fall over upon the slightest of movements of the vehicle from vibrations, which may arise from the skier sitting on a seat inside the vehicle, the user opening or closing a back hatch cargo area of the vehicle, the skier leaning against the vehicle, the skier closing a door, and other disturbances such as wind, other vehicles driving by and vibrating the ground (such as in a parking garage), a person accidentally bumping into the skis, or simply from an unstable balancing point of the ski tips on the ground. Without the use of the sport holder, the skis can slide along the side of the vehicle and damage the vehicle by scratching the paint with the edges, bindings or poles of the skis. The skis could also hit other parts of the vehicle, such as the outside mirrors, which may damage and scratch the skis itself, chip the ski bottoms, fall into puddles and become soiled, as well as other damages that may be inflicted on the skis and/or vehicle. Other common problems exist, for instance, where the skier may remove the skis from a roof or hatch rack, which often means that the skier must leave immediately with them, rather than placing the skis against the vehicle. Instead, the skier might choose to simply place the skis on the ground, which is somewhat impractical.

The reverse is often true when the skier is finished with skiing at the end of the day. Carrying the skis to the car often means placing the skis and poles against the car to unlock and open the roof or hatch rack, then opening the car door and sitting on the inside seats or hatch area to remove the skier's boots. In that case, the skier needs to find a place to rest the skis in order to get organized and repack the skis at the end of the day. Again, the slightest of movements can cause the skis to slide along the side of the vehicle, causing the same damage that the skier tried to avoid at the start of the day.

Hence, in one embodiment, the present disclosure provides a portable sport holder that is directed to permitting the skier to temporarily rest the skis and/or poles against their vehicle, while also preventing the skis and poles from sliding along the vehicle and causing extensive damage to the vehicle. In some embodiments, the sport holder is secured in the door molding by closing a thin, strong piece of rubber or silicone type of pliable material (identified as the “neck”) in the top area of the door and having the door close and secure it so that it cannot be pulled or dislodged from the door area while the skier is gone for the day. The sport holder may further include a “head” portion at an end of the neck that is placed inside the vehicle and prevents the sport holder from being dislodged. For example, someone may try to pull the holder from the vehicle if it were loose or not firmly in the door molding. The head portion may be sized sufficiently so that it cannot be pulled through the door seam.

The head of the sport holder device may also attach to an auto or roof rack provided on top of a vehicle, such as an SUV-type vehicle which typically includes a roof rack. The head may attach to the roof rack by catching a bar on the rack and draping over the side of the vehicle to support the remaining body of the sport holder. In some embodiments, the head may be fed under through a space between the roof rack bar and vehicle, and threaded back through slot or opening disposed on the neck to attach the head to the neck, thus forming a semicircular fitting around the roof rack. For instance, the head may be fed through the opening in the neck (or a slot in the center of the neck material) where the head protrudes above the flat neck area. A locking device having a key or combination lock may then be inserted in a loop provided on the back of the head and secured so the sport holder cannot be stolen or removed from the vehicle. This allows the sport holder device to be mounted to the vehicle at the beginning of the ski day and used to valet the skis and poles while preparing to go skiing, then remain securely attached to the vehicle all day, worry free of theft but ready for the end of the day as a place to temporarily hold the skis while preparing to return home. For example, the sport holder holds the equipment upright while opening the car, roof rack, or ski holder, and while removing boots and other ski clothing at the end of the day. In this way, the sport holder provides a safe storage place and worry free valet. After the skis are secured in the vehicle and the skier is ready to return home, the sport holder device can be removed from the door or roof bar and placed in the vehicle.

If the skier decides not to return to the vehicle, but instead decides to transport the skis to an inside condo or other lodging at the ski resort, then a second option is available. The sport holder device may be removed from the vehicle and carried along with the skis to the inside building. Here again is the dilemma of where to store the skis once inside a condo. As an example, the skier can lean the skis against a corner, hoping that they are out of the way and do not get bumped and thus slide down the walls, damaging both the skis and walls. Other attempts to store the equipment include leaning the skis in a closet, a room or against another device on the wall, such as a thermostat, light switch, wall lamp or some protrusion that can balance the skis. The sport holder device can be removed from the vehicle, easily rinsed off (if there is road dirt from the day), and using the head, which may include a “U” clip, hung over any door. The skis may then be placed into a “V” shaped stabilizer disposed on the sport holder, as described in further detail below. In this case, the skis and poles may be hung out of the way inside or outside the door, suspended above the floor where they will not fall and damage the walls, floor, skis and bindings. This option is also ideal for the end of the season when storing the skis and poles in a closet, garage, or the like. To do so, the sport holder may be hung over a door or looped and secured onto itself over a rod, where it is available to store the skis and poles until next season. In another aspect, the neck can be detached from the body of the sport holder, which can be permanently or temporarily attached to a wall, door, closet, or other structure for long term storage of the skis and/or other equipment. In this way, the sport holder may provide portable and/or fixed means for storage of the equipment, thereby offering a variety of different options for its placement and use.

It is contemplated that the sport holder provides multiple other applications. For instance, after ski season the sport holder may be used outside the vehicle to hold a variety of sports, camping and other equipment transported in the vehicle. The sport holder can be attached to the vehicle as described above and used to hold fishing rods while getting on waders and other gear, hang waders while the user prepares or finishes fishing, hold a shot gun or rifle against the vehicle, or generally secure anything temporarily that can fit within the sport holder. In this way, the user is hands-free and worry-free about a sliding piece of equipment that is conventionally balanced precariously against the vehicle while preparing for an event. The sport holder may further include predrilled holes configured to receive a bungee or other cord that can be wrapped around the equipment and reattached by the free end of the bungee cord to the sport holder. The bungee or cord may further secure a piece of equipment, object, tool, bike, or the like to prevent the object from falling or moving.

It is further contemplated that the sport holder, which may be referred to as a ski valet, can also be used in a retail store to hold skis and sports equipment by hanging the sport holder over a door or wall. Alternatively, the sport holder may be mounted directly onto a wall, door, or other surface by attaching it with screws, nails or the like using the neck area without the “U” clip provided on the head. In that case, the sport holder may function as a display stand for retail skis and sports equipment for many outdoor sports, including hunting gear, fishing gear, and so on. The sport holder may comprise arms extending from the body with grommet holes, so that a plurality of sport holders can be attached in sequence to form multiple sport holder units. For instance, the plurality of sport holders may be connected to each other by inserting an attachment or protrusion provided on the back of the subsequent sport holder into the first sport holder's arm in the grommet hole to stabilize the subsequent sport holder. This sequence may be repeated to form a row of display sport holders in order to hang and display equipment, such as skis. It is contemplated that multiple sport holders may be coupled together in a wide range of situations and environments to conveniently and securely hold multiple units of skis. It is further contemplated that the sport holder may be used in any scenario where the “U” clip on the head can be temporarily hung to secure skis or other equipment, such as with a lift line operator, a ski racing starting port, a restaurant that serves après ski patrons and needs a place to allow for skis to be secured yet does not want a permanent structure year round, and the like.

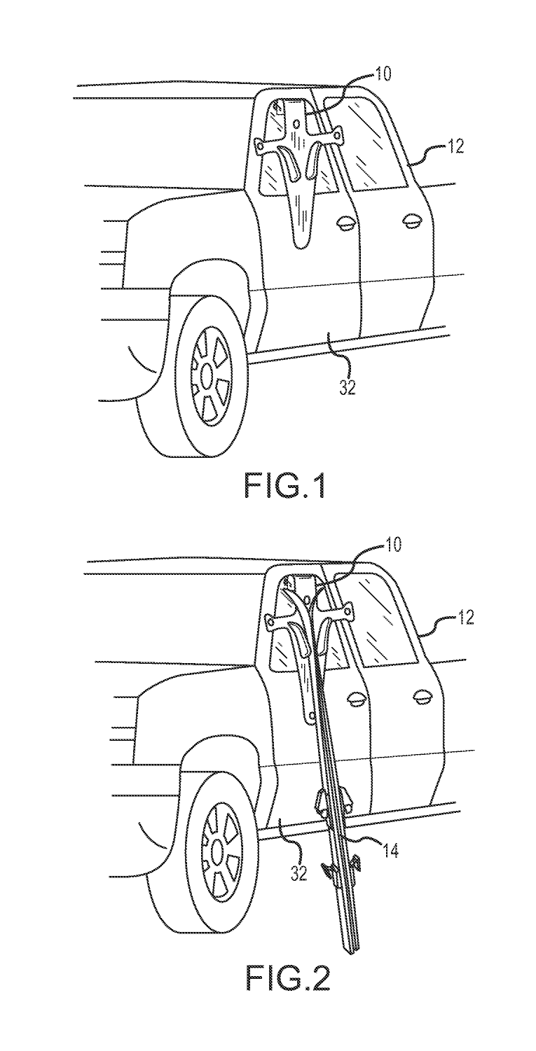

Turning now to FIGS. 1-7, a sport holder 10 according to various embodiments of the present disclosure is shown. In particular, FIG. 1 illustrates the sport holder 10 deployed on a vehicle 12, such as a door of a parked vehicle at a ski venue parking lot. FIG. 2 illustrates the sport holder 10 deployed on the vehicle 12 and having secured therein a piece of equipment 14, such as a pair of skis. It is contemplated that the sport holder 10 provides temporary, stable support for maintaining the piece of equipment 14 in an upright and vertical position. The sport holder 10 prevents scratching of the vehicle and slipping of the piece of equipment 14. The piece of equipment 14 shown herein is a pair of skis, however, it is contemplated that any equipment and/or combination of equipment may be securely received by the sport holder 10, such as skis with ski poles, and other sporting equipment, outdoor gear, clothing, fishing and hunting vests, waders, tools, and the like, as described above.

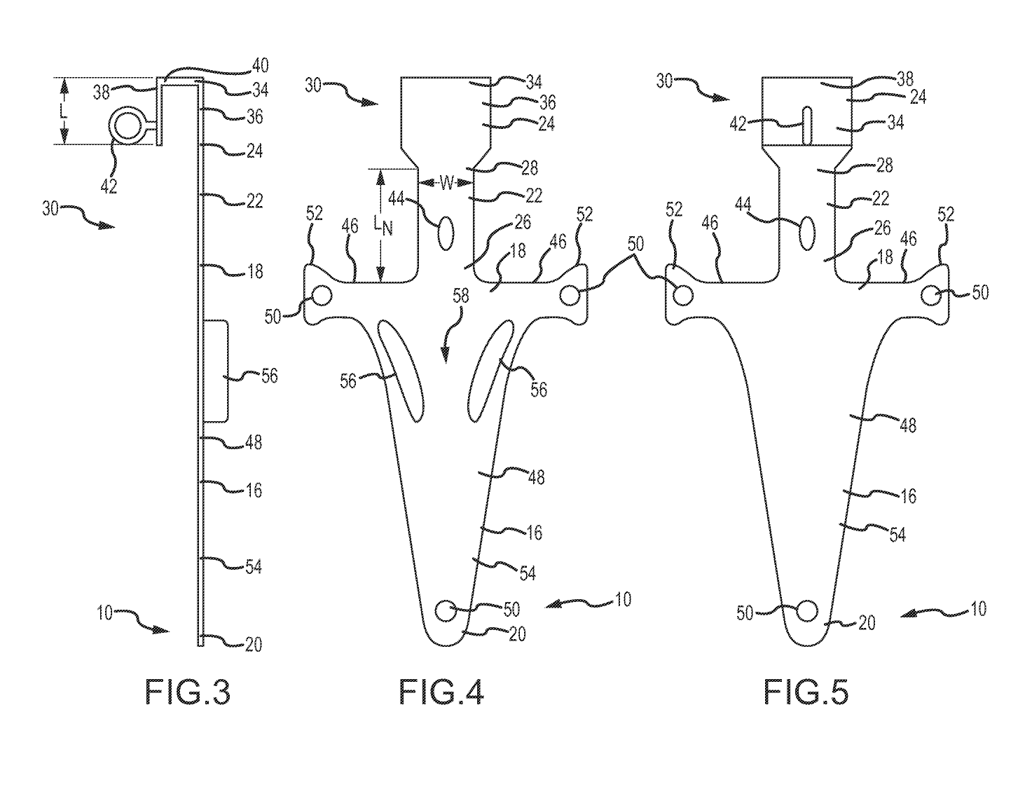

Turning now to FIGS. 3-5, the sport holder 10 comprises a planar body 16 having an upper or first end 18 and a lower or second end 20. The first end 18 extends to an elongate neck 22, which further extends to a head 24. More particularly, the elongate neck 22 comprises a proximal end 26 and a distal end 28, whereby the proximal end 26 is integrally formed with the first end 18 of the body 16, and the distal end 28 is integrally formed with the head 24. In another aspect, the sport holder 10 is constructed as a single, integral unit, such as shaped from stamping a sheet of rubber, vinyl, and/or a plurality of stamped sheets fused or adhered together into a single unit. In another aspect, it is contemplated that the body 16, the neck 22, and/or the head 24 are formed from different materials. Merely by way of example, the head 24 may be formed from metal, metal coated or covered in vinyl, rubber, Nylon, Sommos, elastomers, Duraform, Polyamide, silicone-like surfaces, and/or other soft, pliable material. In a different aspect, the head 24 or any other portion of the sport holder 10 is constructed from a liquid or melted material injected into a mold or tooling, such as plastic, to form a stiff bracket that supports the weight of the sport holder 10 in addition to the piece of equipment 14 without breaking or deforming. Still, in other embodiments, it is contemplated that at least one or more of the body 16, the neck 22, and the head 24 are separable components and adapted to attach to one another by screws, slots, press-fits, hooks, latches, and the like. The sport holder 10 may further be painted and/or covered with a variety of colors and patterns.

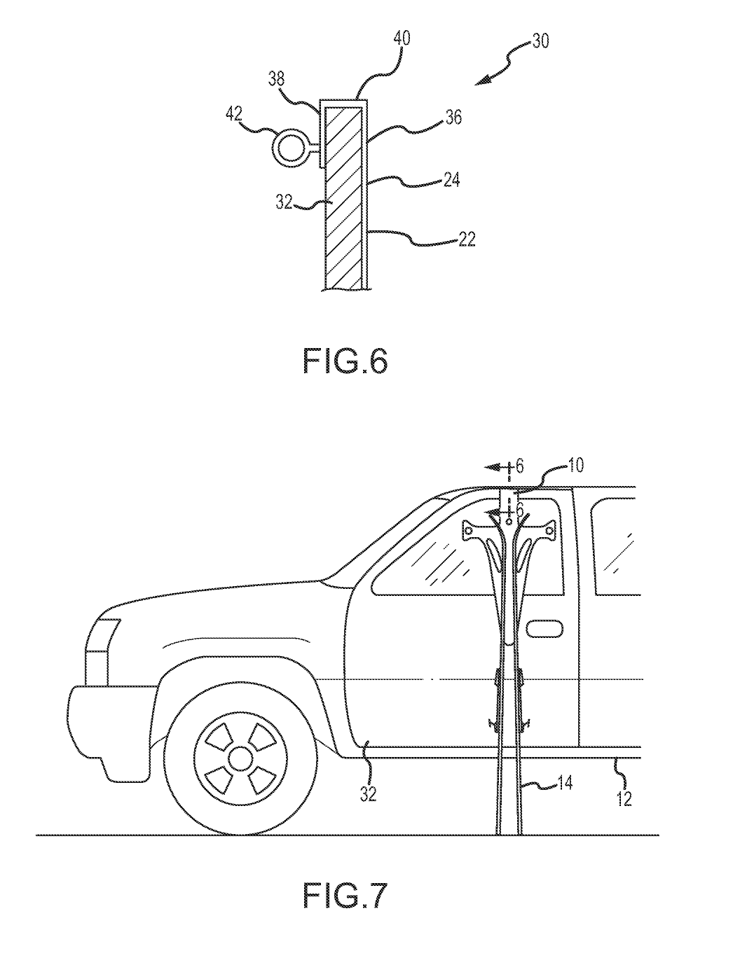

Referring again to FIGS. 3-5, the head 24 of the sport holder 10 may be referred to as a pommel or a top bracket. The head 24 generally includes a peripheral or end portion, such as a top portion 30, of the sport holder 10 that may be configured to hook onto a vehicle door 32 (see FIG. 1) to engage an inside portion of the vehicle door 32 and/or the vehicle 12, hook onto a roof rack bar (not shown), and/or attach to any bar or structure on the vehicle 12 or elsewhere, such as on a wall mount or in a closet. As shown in FIGS. 3-5, in one embodiment, the head 24 includes a U-shaped mounting bracket 34 for hookingly engaging and/or clamping the sport holder 10 to a variety of structures. In reference to FIGS. 3 and 6, it is contemplated that at least a portion of the U-shaped mounting bracket 34 is thin-walled to permit the U-shaped mounting bracket 34 to securingly engage the vehicle door 32 without interfering with closing the door 32. In particular, the U-shaped mounting bracket 34 defines a first wall 36, a second wall 38, and a central wall 40 extending transversely between the first and second walls 36,38. In practice, the central wall 40, and/or portions of the first and second walls 36,38, are captured or compressed between the vehicle door 32 and the vehicle 12 when deployed. Further, at least a portion of the central wall 40 and/or the second wall 38 is adapted to extend within an interior of the vehicle 12. As shown in FIG. 6, the head 24 is adapted to wrap around an edge portion of the vehicle door 32, and/or other mounting structure.

As shown in FIG. 3, it is contemplated that at least one of the walls 36,38,40 provides a thin-walled profile. The thin-walled profile may define a thickness of about 1.0 mm to about 6.0 mm; more preferably, the thin-walled profile defines a thickness of about 2.0 mm to about 4.0 mm; most preferably, the thin-walled profile is a thickness of about 3.0 mm. In another aspect, it is contemplated that the second wall 38 defines a length L that is long enough to securely retain or hook the sport holder 10 against the mounting structure, such as the vehicle door 32, without slippage. In some embodiments, the length L is between about 2 inches to about 9 inches. In some embodiments, an adjustable strap may be wound about itself to allow for an increase or decrease in the length L.

Further shown in FIGS. 3, 5, and 6, a ring 42, such as a metal ring, is provided protruding from a portion of the second wall 38. The ring 42 may provide alternative mounting means for the sport holder 10. For instance, the head 24 and/or a portion of the neck 22 may be wrapped around a mounting structure, such as a roof rack and/or bar, by wrapping the head 24 over and then back under the bar so that the loop 42 can be inserted through a slit 44 disposed on the neck 44. In this way, the head 24 and a portion of the neck 22 are flexible and form a loop for receiving the mounting structure therethrough. It is further contemplated that a plurality of slits 44 may be provided to permit formation of different loop diameters so that the sport holder 10 can accommodate different sized mounting structures. For instance, the plurality of slits 44 may be disposed in a line vertically along the length of the neck 22 without compromising the structural integrity of the neck 22. In one embodiment, 2-4 slits are provided on the neck 22. In another embodiment, three slits are provided along the neck 22. It is further contemplated that in the loop-around configuration, the ring 42 exposed through the slit 44 permits attachment of a lock (not shown), such as a key or combination lock, to prevent removal and/or slippage of the sport holder 10 when attached to the mounting structure.

In another aspect, it is contemplated that the head 24 can be removed from the neck 22 using two to four screws with inserts to attach or detach the head 24 from the neck 22, for instance if the head 24 is not desired and/or the head 24 is too large to wrap around the mounting structure. For instance, the head 24 and/or the U-shaped mounting bracket 34 of the head 24 can be removed. The neck 22 can be wrapped around the mounting structure, such as the bar. The head 24 can then be secured by an attachment using screws, Phillips screws, a spring loaded pressure device, or other attachment that is inserted into the neck 22 from the head 24 to hold the head 24 in place. Such securing screws or locking device may be hidden in between the neck 22 and the head 24 to prevent access thereto. It is contemplated that this configuration protects the sport holder 10 from theft. Further, the ring 42 may be passed through the slit 44 to receive locking attachments as described previously.

In reference to FIG. 4, the neck 22 couples the head 24 to the body 16. The neck 22 operates as an extension or connection to the head 24 and the body 16, such as the proximal end 26 of the body 16 which may further define a pair of shoulders 46. The neck 22 may be formed from a soft vinyl, a rubber like material, silicone or other pliable material that can be squeezed and compressed yet retain the original shape and not permanently deform, stretch, break or fatigue. The neck 22 is adapted to be inserted and closed in the space of the vehicle door 32 inside a soft seal that may be disposed around the top edge of the door 32. The neck 22 may be constructed so that it will not damage the vehicle door 32, such as stripping or permanently deform the door 32, and allow the neck 22 to function as a seal inside the doorframe to keep outside elements from leaking inside the vehicle. Further, the neck 22 provides a sufficient length that may vary depending on the use and type of vehicle 12 or mounting structure. Merely by way of example, as shown in FIG. 4, the neck 22 may define a length L_{N} of about 2.0 inches to about 4.0 inches. In one embodiment, the neck 22 is adapted to fit and extend inside the vehicle door 32 with enough material to securely hold the body 16 of the sport holder 10. The head 24 can be attached and located within the interior of the vehicle door 32, or may be removed when not in use to hang over an interior door. The neck 22 may also be secured independently of the head 24, such as permanently secured to a wall or inside structure in single or multiple units. For instance, the slit 44 may receive a nail on the wall to hang the sport holder 10 with or without the head 24 attached. Further, the neck 22 may be ribbed on one or both sides to provide additional traction against slippage along the mounting structure or slippage of the piece of equipment 14. In another aspect, it is contemplated that a width W of the neck 22 is narrower than the head 24 and/or the body 16 portions of the sport holder 10.

Referring now to FIGS. 4 and 5, the body 16 defines a guard 48 with a pair of arms or the shoulders 46 extending outwardly therefrom. The guard 48 may be configured to hold the piece of equipment 14 resting against it, such as a pair of skis as shown in FIG. 7. The shoulders 46 may provide stabilization to the guard 48. Further, one or more grommets 50 may be disposed on body 16. For instance, each shoulder 46 may have a grommet 50 disposed toward a flared, outer end 52 thereof. It is contemplated that the grommets 50 may receive further attachment means, such as an elastic bungee cord (not shown) for attachment in a ferrule-like design. Further, the grommets 50 may permit a plurality of sport holders 10 to be attached together by aligning the grommets 50 of adjacent sport holders and inserting securing means therethrough. In another aspect, it is contemplated that the flared, outer ends 52 further enhance stability of the sport holder 10.

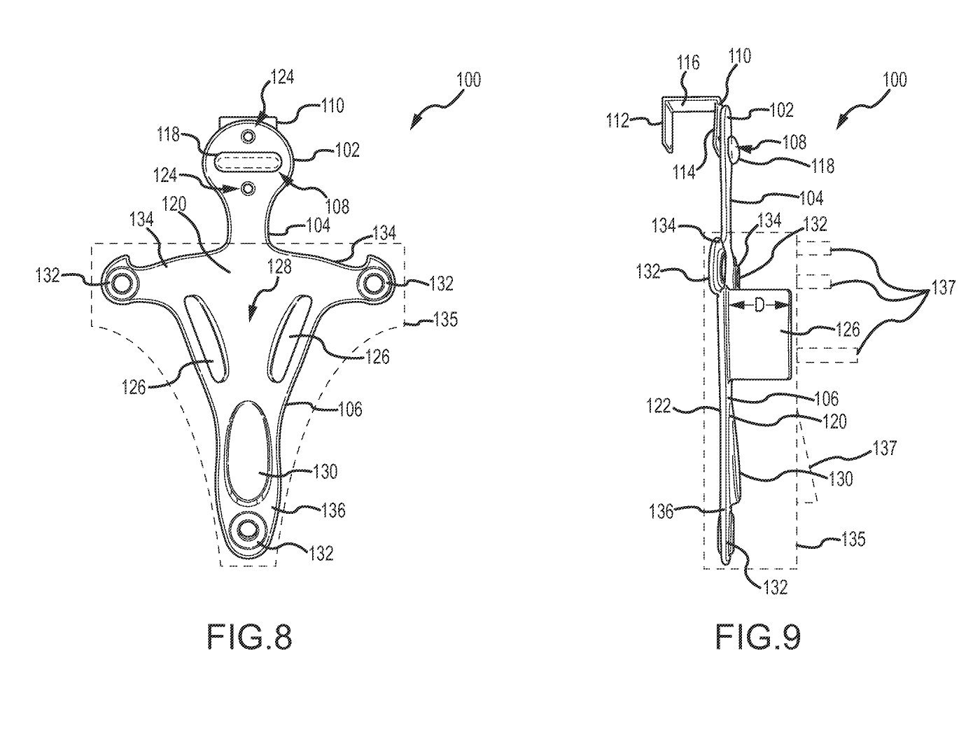

As shown in FIGS. 4 and 5, the shoulders 46 protrude from opposing sides of the guard 48 and may be slightly angled outwardly for easier acceptance of equipment, such as ski pole straps. In a different aspect, the shoulders 46 provide structure for receiving clips of a different sport-specific overlay or sleeve (see FIGS. 8 and 9), which can be used to modify the sport holder 10 from a particular sport-specific anchoring mechanism to a different sport-specific anchoring mechanism. Merely by way of example, the sport holder 10 may be skiing-specific and converted using the overlay to secure equipment for hunting or fishing, including hanging waders, other clothing, equipment, and/or sports gear. In one embodiment, the sport-specific overlay continues to smoothly cover a portion of all of a V-shaped sternum 54 of the guard 48. The sport-specific overlay may be designed to hook, press-fit, or otherwise attach to the shoulders 46, the grommets 50, and/or the flared outer ends 52. For instance, the sport-specific overlay or sleeve can be adapted to clip from behind three grommets 50 provided on the shoulders 46 and the second end 20 of the sport holder 10.

Still in reference to FIGS. 4 and 5, the shoulders 46 may be formed from a material or covering that will not scratch the piece of equipment 14, such as the skis, but will grip and securely hold the skis. The material should be strong enough to support the weight of the piece of equipment 14 without deforming or only temporarily deforming. A ribbed texture on a side facing the equipment 14 or a backside facing a mounting surface may be provided to provide extra surface area for a more secure attachment. It is contemplated that even with the ribbed texture, the piece of equipment 14 can be easily removed with a slight upward force. In another aspect, it is contemplated that length L_{N} of the neck 22 is long enough to be secured by the vehicle door 32 while permitting the V-shaped sternum area 54 to allow the piece of equipment 14 to rest against the area 54 and to be positioned away from the vehicle 12 with a lowermost portion of the equipment 14, such as the bottom of the skis, resting on the ground. Then, when the sport holder 10 is taken inside and hung over a door, the V-shaped sternum area 54 will support the piece of equipment 14 securely, allowing room for the door to close such that the piece of equipment 14 does not protrude from above the door frame.

As shown in FIGS. 3, 4, and 7, it is contemplated that the body 16 provides one or more projections 56 disposed thereon to engage the piece of equipment 14. The projections 56 may be slanted, longitudinal walls, such as a pair of projections 56 disposed in a V-shaped arrangement to define a basket 58 for receiving and stabilizing the piece of equipment 14 (see FIGS. 4 and 7). It is contemplated that basket 58 is positioned on the guard 48 of the body 16 at a portion that is low enough for the door to close and high enough for the piece of equipment 14 to stand on a ground when used outside against a vehicle. For instance, the basket 58 is provided at a height that permits the skis to clear a door frame and also permits a lowermost portion of the skis to rest on the ground. In this way, it is contemplated that the basket 58 and/or the adjustable neck 22 is adapted to accommodate a particular vehicle height and/or multiple different vehicle heights. Further, it is contemplated that the body 16 is long enough to protect the mounting surface, such as the vehicle door 32, from contacting the skis. In this way, the body 16 may be constructed as a slight angled shim where the skis rest against and are directed away from the sport holder 10 by a few degrees to allow space for bindings and ski brakes.

Referring back to FIGS. 1-7, it is contemplated that the sport holder 10 resembles a sword shape in design. The sport holder 10 may be formed with a mold using injectable rubber, silicone, plastic or other polymer that is stamped from suitable material in sheets and then fused with different layers to yield a strong yet pliable device. Further, the sport holder 10 is adapted to withstand outdoor usage and is versatile for indoor usage, such as when hung on a door or secured to a wall or other structure. The sport holder 10 may be made as a single unit or multiple units. In one aspect, the single units may be attached with male-female side fingers (not shown) that interlock, or by using an accessory that connects multiple units at the body-to-body area.

Turning now to FIGS. 8 and 9, other embodiments for a sport holder 100 are shown. It is contemplated that the sport holder 100 may comprise similar features and functions as those described in relation to the sport holder 10. The sport holder 100 may include any features and functions of the sport holder 10 in addition to, or as an alternative to, any of the proceeding embodiments.

For instance, the sport holder 100 comprises a head 102, a neck 104, and a body 106. The head 102 may provide a slot 108 for fitting a separable mounting hook 110. In one embodiment as shown in FIGS. 8 and 9, the slot 108 is longitudinal-shaped to correspond with the shape of the mounting hook 110, which may be shaped similar to the U-shaped mounting bracket 34 disclosed above. As shown in FIG. 9, the mounting hook 110 may provide a first wall 112 and a second wall 114 with a central wall 116 disposed therebetween. The walls 112,114,116 may be adjoined at right angles to provide a rectangular-shaped hook, or at any other angles, number of walls or shapes for accommodating any the mounting structure. The mounting hook 110 may further be flexed or deformed by a user to accommodate the shape of the mounting structure. Further, the second wall 114 may provide a stop 118, such as an enlarged securing area sized larger than the slot 108, to engage against a periphery of the slot 108 and prevent the head 102 from slipping off of the mounting hook 110. In the present embodiment, the stop 118 is longitudinal-shaped and abuts a front surface 120 of the sport holder 100, while the remaining walls 112,114,116 of the mounting hook 110 are disposed on a back surface 122 of the holder 100. In a particular aspect, the second wall 114 may provide ribbings or other textured surfaces for securely abutting against the back surface 122 at the head 102 portion.

In yet another aspect, the U-shaped mounting bracket 34 (FIGS. 3-5) or the separable mounting hook 110 (FIGS. 8 and 9) comprises a rubber-like material, cloth, or nylon that can be adjusted to various lengths by sliding the material through adjustable securing clips to shorten or lengthen a vertical length of the bracket 34 or hook 110. Merely by way of example, the second wall 114 of the mounting hook 110 can have a variable length that a user can set by securing the length with the adjustable clip(s). The second wall 114 further provides the stop 118 that clips or slides through the slot 108 disposed on the head 24. In another aspect, the U-shaped mounting bracket 34, the mounting hook 110, and/or more particularly, the second wall 114, can be threaded through the slot 108 to a desired length and subsequently knotted at its end by the user so that it will not slip through the slot 108. Thereafter, the remainder of the U-shaped mounting bracket 34 and/or the mounting hook 110, such as the first wall 112 and the central wall 116, may be slung over an open car door, such as a soft molding lining the car door, to securely hold the sport holder 10 or 100 at a desirable height due to the adjustable length of the second wall 114. The adjustable length may depend on a height of the vehicle. In yet another aspect, the second wall 114 may comprise a slot for receiving an adjustable strap, such as a nylon strap, which is further connected with the head 102. Further, the bracket 34 and/or mounting hook 110 may be closed inside the vehicle without damage to the door and secured to the sport holder 10 or 100 hanging on the outside of the vehicle, yet trapping the “U” strap inside and providing resistance to a force pulling it free or being stolen. The “U” clip may further have a place for an attachment where an over the door hook can be easily inserted to hang suspended from a door, for instance in a condo, as described above.

Further shown in FIG. 8, the head 102 includes a pair of holes 124 for providing alternative mounting means. For instance, the holes 124 may be disposed surrounding the slot 108 to engage nails disposed on a wall. Although two holes 124 are provided, it is contemplated that any number of holes 124 may be provided in any arrangement. Similarly, it is contemplated that more than one slot 108 can be provided on the head 102 for receiving the mounting hook 110 to give a user adjustable mounting options. It is contemplated that the mounting hook 110 is formed from rubber, cloth, or nylon strap-like material, which may be adjustable.

As further shown in FIG. 8, the body 106 provides a pair of projections 126 in a V-shaped arrangement to define a receiving V-shaped basket 128. As shown in FIG. 9, in some embodiments, the projections 126 may have a depth D of about 2.5 inches to about 5.0 inches. It is contemplated that the projections 126 may have various depths and positions to accommodate a specific piece of equipment 14. Further, as shown in FIGS. 8 and 9, the body 106 may provide a protruding ramp 130 below the basket 128 for angling the piece of equipment 14 outwardly. The ramp 130 and/or the projections 126 may be covered in soft material to provide cushioning to the piece of equipment 14. Similarly, it is contemplated that the back surface 122 may be cushioned to protect to the mounting surface.

Still referring to FIG. 8, three grommets 132 are provided on the body 106. More particularly, the grommets 132 are disposed near peripheral regions the body 106, such as at a pair of shoulders 134 and a bottom tongue 136. It is contemplated that the grommets 132 are adapted to engage a preformed plastic sport-specific shell 135 as described above. The sport-specific shell 135 may be slid over the front surface 120 of the sport holder 100 and over the angled projections 126 to clip into the three grommets 132. Further, end portions of the shoulders 134 may be hook-shaped to further assist in engaging the shell. Merely by way of example, the sport-specific shell 135 can be inserted over the two projections 126, which may initially function as ski supports, and clip from behind the three grommets 132 to provide various platforms for gear utilized in hunting or fishing, such as support for receiving rifles, guns, clothing such as vests, ammunition, game, fishing, mountain bikes, and the like, for a variety of outdoor activities where gear may be temporarily secured. More particularly, the sport-specific overlay may provide one or more additional projections 137 similar to the two angled projections 126 but angled at a different degree that may be more suitable for holding other gear. In another aspect, the one or more additional projections 137 provided on the sport-specific overlay may define a shallower or greater depth than the depth D, provide different shapes than the projection 126, and be arranged in geometric configurations other than V-shaped. Merely by way of example, the additional projection 137 of the sport specific overlay may define a depth d between about 5.0 mm to about 10.0 mm. A plurality of additional projections 137 may be provided on the sport specific 135 overlay to form a flat shelf, or a wider or narrower V-shaped basket for holding other gear. Further, it is contemplated that the sport-specific overlay may be provided to alter a color and/or pattern, or other appearance, of the sport holder.

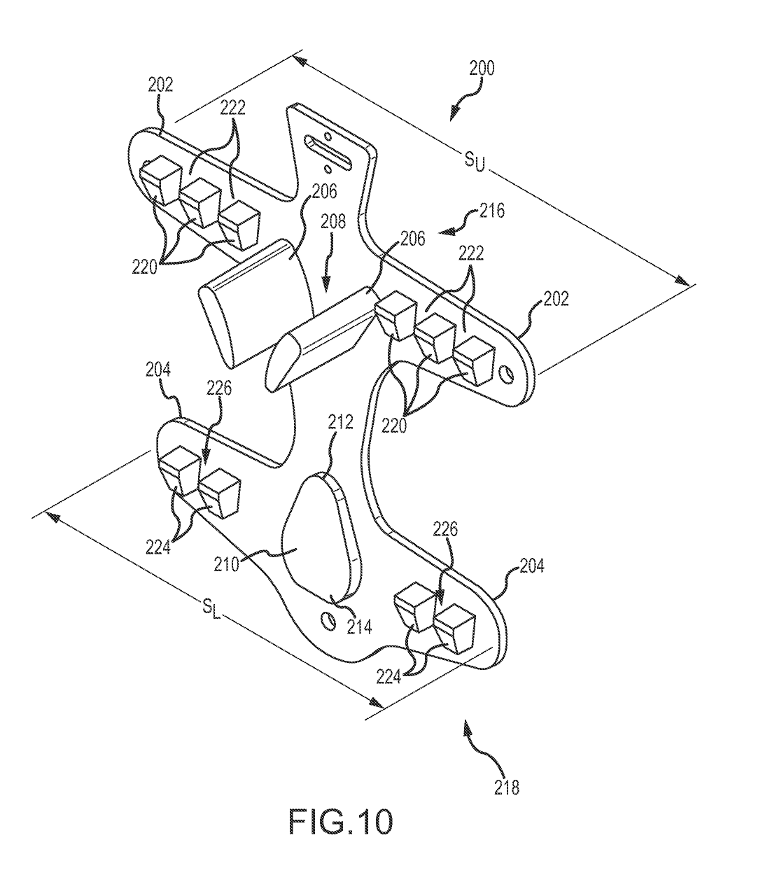

Turning now to FIG. 10, another embodiment of a sport holder 200, also referred to as a sport valet, is shown. The sport holder 200 may be similar to any of the embodiments described herein, and offer further embodiments that may be used, additionally or alternatively, with the other embodiments. For instance, the sport holder 200 includes two pairs of shoulders, such as upper shoulders 202 and lower shoulders 204. A pair of projections 206 located between the pair of upper shoulders 202 are angled in a V-shape arrangement to form a basket 208 that is sized to securely hold a desired sports equipment therein. A ramp 210 located between the pair of lower shoulders 204 and aligned with the basket 208 may be angled outwardly from a top part 212 to a bottom part 214 of the ramp 210 to direct the sports equipment outwardly away from a mounting surface, such as a car, door, or wall.

Still in reference to FIG. 10, a plurality of secondary projections is provided at an upper portion 216 and a lower portion 218 of the sport holder 200 to secure other sport equipment. For instance, the upper shoulders 202 located at the upper portion 216 of the sports holder 200 each include three upper projections 220 defining two upper slots 222 therebetween. In practice, each upper slot 222 may hold additional sports equipment, such as a fishing rod. Similarly, the pair of lower shoulders 204 located at the lower portion 218 of the sport holder each include two lower projections 224 forming a lower slot 226 therebetween. Each lower slot 226 may receive additional sports equipment, such as a rifle and a gun barrel. In a different aspect, each lower projection 224 may serve as ramps to angle outwardly a sports equipment inserted in any of the upper slots 222. It is contemplated that any combination and number of projections and slots may be provided on the upper and lower shoulders 202,204 to hold additional sports equipment. In this way, the sport holder 200 may be applicable for a securing equipment for a variety of different applications, such as skiing, hunting, fishing, tennis, golf, baseball, camping, and so on. Even further, the projections 220,224 may be removable and configured in other arrangements on the sport holder 200 so that a user can arrange the projections 220,224 as desired. In another aspect, it is contemplated that a horizontal span S_{U} of the upper shoulders 202 may be longer, shorter, or the same as a horizontal span S_{L} of the lower shoulders 204.

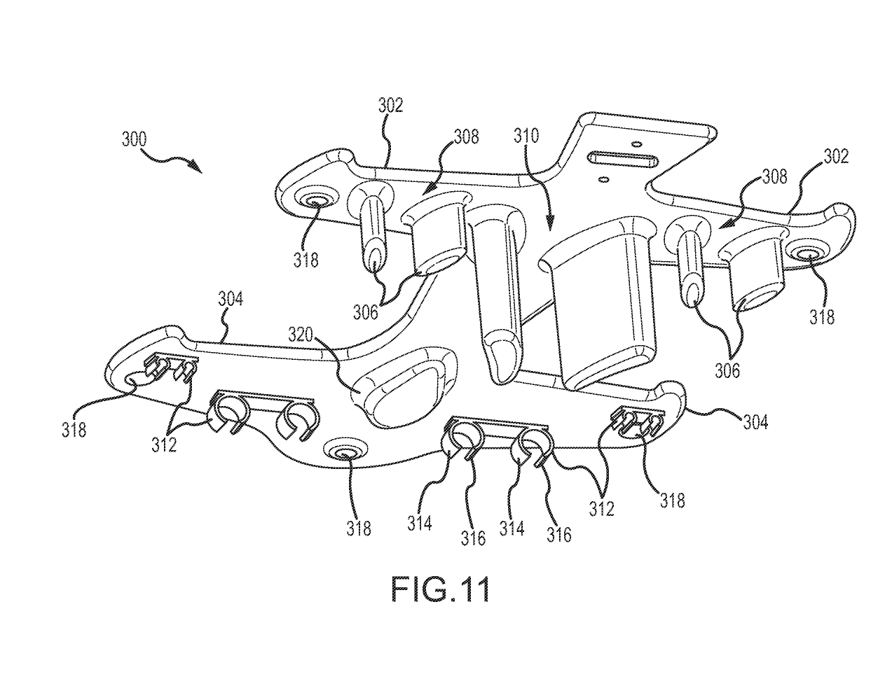

Turning to FIG. 11, another sport holder 300 is described. In general, the sport holder 300 is similar to the sport holder 200 described above, and may include any embodiments alternatively or in combination with the sport holders 10, 100, 200 described previously. In a particular aspect, the sport holder 300 includes a variety of secondary projections provided on upper and lower shoulders 302, 304. The upper shoulders 302 include four upper projections 306 that are angled to form two v-shaped upper baskets 308 placed on either side of a central v-shaped basket 310. The upper baskets 308 may be smaller the central basket 310 and formed from projections that are smaller in size than those defining the central basket. It is contemplated that the upper and central baskets 308,310 are shaped to hold a variety of sports equipment as described herein.

As further shown in FIG. 11, the lower shoulders 304 include lower projections 312 that define a variety of clips, for instance for holding fishing rods or other sport equipment. In particular, the lower shoulder 304 includes four lower projections 312 of various sizes. The two outermost lower projections 312a have double clips that are each smaller in diameter than clips provided on the two innermost lower projections 312b. Each clip is generally circular in shape and formed by two curved, flexible arms 314, 316, extending outwardly from the sport holder 300. The flexible arms 314, 316 are adapted to temporarily deform and snap around a sport equipment inserted therein. In some embodiments, the diameter of each clip is dependent on the size of the sport equipment intended to be secured therein. It is noted that any combination of the same or different projections may be provided on the sport holder 300. Further, the sport holder 300 can comprise one or more mounting holes 318 placed on peripheral or inner portions of the sport holder 300. For instance, the upper and lower shoulders 302,304 may each have a mounting hole 318 disposed toward an end thereof. An additional mounting hole 318 may be provided along a bottom portion of the sport holder 318, for instance, below a ramp 320 that is positioned below the central basket 310.

What is claimed is:

1. A portable sport holder, comprising:
a planar body having an upper end, a lower end, and a pair of projections disposed between the upper and lower ends for receiving and stabilizing a piece of equipment, wherein the pair of projections forms a V-shaped basket for receiving the piece of equipment therein;
a neck extending from the upper end of the body; and
a head extending from the neck, wherein the head is adapted to removably couple the sport holder to a mounting surface.

2. The sport holder of claim 1, wherein at least one of the head and the neck is flexible.

3. The sport holder of claim 1, wherein the head is removably coupled to the neck.

4. The sport holder of claim 1, wherein the head, the neck, and the body are integrally formed.

5. The sport holder of claim 1, wherein the head includes a U-shaped mounting bracket that is adapted to hookingly engage, clamp, and loop around the mounting surface.

6. The sport holder of claim 5, wherein the U-shaped mounting bracket provides a ring adapted to be secured through a slit disposed on a portion of the neck, further wherein the ring is configured to receive a locking mechanism.

7. The sport holder of claim 1, wherein the head includes a slot for engaging a separable mounting hook therethrough.

8. The sport holder of claim 7, wherein the mounting hook provides a stop for abutting a periphery of the slot and preventing separation of the mounting hook from the head.

9. The sport holder of claim 1, wherein the body further comprises a protruding ramp disposed below the V-shaped basket for angling the piece of equipment outwardly away from the sport holder.

10. The sport holder of claim 1, wherein the body further includes a pair of shoulders at the upper end thereof, further wherein each shoulder includes a hooked end portion and a grommet.

11. The sport holder of claim 1, wherein the body includes two pairs of shoulders, wherein a pair of upper shoulders is disposed at an upper portion of the body and a pair of lower shoulders is disposed at a lower portion of the body.

12. The sport holder of claim 11, further comprising a plurality of secondary protrusions provided on at least one of the pair of upper shoulders and lower shoulders.

13. A portable sport holder, comprising:
a body having an upper end, a lower end, and at least one angled projection disposed between the upper and lower ends;
a neck extending from the upper end of the body; and
a head extending from the neck, wherein the head is adapted to removably couple the sport holder to a mounting surface,
wherein the at least one angled projection is adapted to removably secure a piece of equipment, and
wherein the at least one angled projection is adapted to removably receive a sport-specific overlay.

14. The sport holder of claim 13, wherein the at least one angled projection defines a depth D between about 2 inches to about 5 inches.

15. The sport holder of claim 13, wherein the sport-specific overlay provides at least one additional projection, wherein the at least one additional projection defines a depth d that is different than a depth D defined by the least one angled projection.

16. The sport holder of claim 13, wherein at least a portion of the neck includes ribbing to provide traction against the mounting surface and/or the piece of equipment.

17. A method for attaching a piece of equipment to a portable sport holder, comprising:
providing a body having an upper end, a lower end, and a pair of projections disposed therebetween for receiving and stabilizing a first piece of equipment therein;
providing a neck extending from the upper end of the body, wherein the neck is further adapted to attach to a head that provides a slot therethrough;
inserting a mounting hook through the slot to engage a periphery of the slot against a stop on the mounting hook;
engaging the mounting hook to a mounting surface; and
placing the first piece of equipment between the pair of projections to hang or hold the first piece of equipment therein.

18. The method of claim 17, further comprising the steps of:
removing the first piece of equipment from the pair of projections;
sliding a sport-specific overlay on top of the pair of projections, wherein the sport-specific overlay provides at least one additional projection that is different than the pair of projections; and
engaging a second piece of equipment on the additional projection, wherein the second piece of equipment is shaped differently than the first piece of equipment.

19. The method of claim 18, further comprising snapping at least a portion of the sport-specific overlay onto a pair of lateral shoulders disposed on the body to secure the sport-specific overlay to the body.

20. The method of claim 17, further comprising the step of angling the first piece of equipment away from the sport holder.
